(19) United States
(12) Patent Application Publication
(10) Pub. No.: US 2006/0246371 A1
(43) Pub. Date: Nov. 2, 2006

(54) Photosensitive fluororesin composition, cured film obtained from the composition, and method of forming pattern

(76) Inventors: Akira Nishikawa, Tokyo (JP); Mibuko Shimada, Tokyo (JP); Ken-ichi Yokoyama, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 10/563,749

(22) PCT Filed: Jul. 6, 2004
(86) PCT No.: PCT/JP04/09566

§ 371 Date: Jan. 9, 2006

(30) Foreign Application Priority Data
Jul. 9, 2003 (JP) 2003-272331

(51) Int. Cl. G03C 1/00

(52) U.S. Cl. 430/270.1

(57) ABSTRACT

[PROBLEM TO BE SOLVED] To provide a cured product, which is excellent in the prevention of adherence of a water repellent oil component, finger prints and the like and wiping-off properties (anti-fouling properties) thereof, as well as in thermal shock properties, adhesion or other properties, and a photosensitive fluororesin composition for easily providing the above cured product. [SOLUTION] A photosensitive fluororesin composition comprising (A) a fluorocopolymer, (B) a compound having at least two alkyletherized amino groups in its molecule, (C) a photosensitive acid generating agent, and (D) a solvent, wherein the fluorocopolymer (A) is a copolymer comprising (A1) a structural unit derived from at least one monomer selected from fluoro(meth)acrylic esters, fluoroolefins, and fluoroolefin derivatives and (A2) a structural unit derived from at least one monomer selected from hydroxyl-containing monomers, epoxy-containing monomers, and carboxyl-containing monomers.

### TECHNICAL FIELD

The present invention relates to a photosensitive fluororesin composition and a cured film thereof. More particularly, the present invention relates to a photosensitive fluororesin composition for use, for example, in surface protective films (overcoat films) for displays, semiconductor elements and the like, and a cured film thereof.

### BACKGROUND ART

Silicon sol-gel materials and ultraviolet curing resins possessing excellent scratch resistance have hitherto been extensively used as hardcoat materials for use in displays such as LCDs. Further, polyimide resins possessing excellent heat resistance, mechanical properties or other properties have extensively been used, for example, for surface protective films used in semiconductor elements of electronic equipment. These materials, however, have a problem in that the function of preventing the adherence of soils such as oils, fingerprints or the like is unsatisfactory and, thus, in displays, the visibility is likely to be lowered and, in semiconductor elements, the adherence of water or fouling components is likely to cause malfunction. For this reason, the development of a resin composition that can easily form a protective film possessing excellent anti-fouling properties, scratch resistance and other properties has been desired.

On the other hand, a curable resin composition comprising a fluorocopolymer prepared by polymerizing a fluorine atom-containing monomer and a hydroxyl- or epoxy-containing monomer (patent document 1 (Japanese Patent Laid-Open No. 10-25388/1998)) and a radiation-sensitive resin composition comprising a fluorocopolymer of hexafluoropropylene with an unsaturated carboxylic acid or the like (patent document 2 (Japanese Patent Laid-Open No. 10-319593/1998)) are known as photosensitive fluororesins. Patent documents 1 and 2, however, do not describe that these resin compositions can form a protective film possessing excellent anti-fouling properties, scratch resistance and other properties.

Patent document 1: Japanese Patent Laid-Open No. 10-25388/1998

Patent document 2: Japanese Patent Laid-Open No. 10-319593/1998

### DISCLOSURE OF THE INVENTION PROBLEMS TO BE SOLVED BY THE INVENTION

The present invention has been made with a view to solving the above problems of the prior art, and an object of the present invention is to provide a cured product, which is excellent in the prevention of adherence of a water repellent oil component, finger prints and the like and wiping-off properties (anti-fouling properties) thereof, as well as in thermal shock resistance, adhesion or other properties, and to provide a photosensitive fluororesin composition for easily providing the above cured product. Another object of the present invention is to provide a photosensitive fluororesin composition which, in mounting a semiconductor element, has excellent patternability (resolution) and is suitable for a surface protective film.

A further object of the present invention is to provide a cured film produced by curing the above photosensitive fluororesin composition.

### MEANS FOR SOLVING THE PROBLEMS

The present inventor has made extensive and intensive studies with a view to solving the above problems and, as a result, has found that a photosensitive fluororesin composition comprising a copolymer having a fluorine atom in its molecule can form a cured product possessing excellent anti-fouling properties and other properties. This has led to the completion of the present invention.

Thus, a photosensitive fluororesin composition according to the present invention comprises (A) a copolymer having a fluorine atom in its molecule, (B) a compound having at least two alkyletherized amino groups in its molecule, (C) a photosensitive acid generating agent, and (D) a solvent.

The copolymer (A) having a fluorine atom in its molecule is preferably a copolymer comprising (A1) a structural unit derived from at least one monomer selected from fluoro(meth)acrylic esters, fluoroolefins, and fluoroolefin derivatives and (A2) a structural unit derived from at least one monomer selected from hydroxyl-containing monomers, epoxy-containing monomers, and carboxyl-containing monomers.

Preferably, the copolymer (A) having a fluorine atom in its molecule further comprises (A3) a structural unit derived from at least one monomer selected from vinyl compounds, (meth)acrylic esters, unsaturated carboxylic acid esters, (meth)acrylamides, and unsaturated nitriles.

Preferably, the structural unit (A1) is a structural unit represented by formula (1).

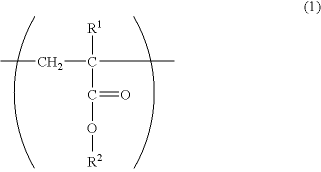

In the formula (1), R¹ represents a hydrogen atom or a methyl group; and R² represents a fluoroalkyl group having 2 to 20 carbon atoms.

The structural unit (A1) may be a structural unit represented by formula (2).

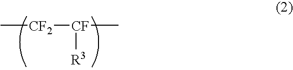

In the formula (2), R³ represents a fluorine atom, a perfluoroalkyl group having 1 to 10 carbon atoms, a perfluoroalkoxy group having 1 to 10 carbon atoms, or a chlorine atom.

Preferably, the structural unit (A2) is a structural unit derived from a phenolic hydroxyl-containing monomer.

Preferably, the copolymer (A) having a fluorine atom in its molecule further comprises a silicon atom. More preferably, the copolymer (A) having a fluorine atom in its molecule further comprises a siloxane structural unit represented by formula (3).

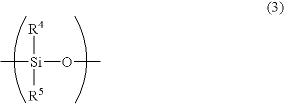

In the formula, R⁴ and R⁵ each independently represent a hydrogen atom, an alkyl group or a halogenated alkyl group having 1 to 10 carbon atoms, or an aryl group having 6 to 20 carbon atoms.

The cured film according to the present invention can be formed by curing the photosensitive fluororesin composition and may have a pattern.

A method for pattern formation according to the present invention comprises the steps of: coating the above photosensitive fluororesin composition onto a support; drying the coating to form a coating film; exposing the coating film to light through a photomask; and then developing the exposed coating film with an alkaline developing solution. Here the exposure is preferably carried out using an exposure light source with an irradiating light wavelength of 300 nm to 500 nm.

A cured film having a pattern according to the present invention can be formed by the above method for pattern formation.

An anti-fouling film according to the present invention comprises the above cured film.

An article and an anti-fouling article according to the present invention are each an article comprising the above cured film or anti-fouling film formed on the surface thereof.

### EFFECT OF THE INVENTION

The present invention can provide a photosensitive fluororesin composition which has excellent patternability by alkali development, and can further provide a cured product which is excellent in the prevention of adherence of a water repellent oil component, finger prints and the like or wiping-off properties thereof, as well as in thermal shock resistance, adhesion or other properties.

### PREFERRED EMBODIMENTS FOR CARRYING OUT THE INVENTION

### Photosensitive Fluororesin Composition

The photosensitive fluororesin composition according to the present invention comprises (A) a copolymer having a fluorine atom in its molecule, (B) a compound having at least two alkyletherized amino groups in its molecule, (C) a photosensitive acid generating agent, and (D) a solvent. In the present invention, if necessary, the photosensitive fluororesin composition may contain alkali-soluble phenolic resins, oxirane ring-containing compounds such as epoxy resins, metal oxide particles, crosslinked fine particles, adhesion aids, sensitizers, leveling agents or other additives.

Components used in the present invention will be described.

(A) Copolymer having a Fluorine Atom in its Molecule:

The copolymer having a fluorine atom in its molecule (hereinafter referred to simply as “fluorocopolymer (A)”) used in the present invention is preferably a copolymer comprising

(A1) a structural unit derived from at least one monomer (a1) selected from fluoro(meth)acrylic esters, fluoroolefins, and fluoroolefin derivatives and (A2) a structural unit derived from at least one monomer (a2) selected from hydroxyl-containing monomers, epoxy-containing monomers, and carboxyl-containing monomers, and

if necessary, (A3) a structural unit derived from at least one monomer (a3) selected from vinyl compounds, (meth)acrylic esters, unsaturated carboxylic acid esters, (meth)acrylamides, and unsaturated nitriles.

Among the above fluorocopolymers (A), a copolymer in which the structural unit (A1) comprises a structural unit represented by formula (1) or (2) is preferred.

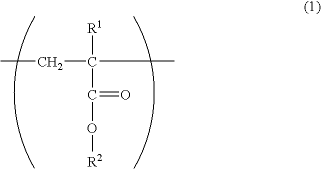

In the formula (1), R¹ represents a hydrogen atom or a methyl group; and R² represents a fluoroalkyl group having 2 to 20 carbon atoms.

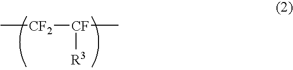

In the formula (2), R³ represents a fluorine atom, a perfluoroalkyl group having 1 to 10 carbon atoms, a perfluoroalkoxy group having 1 to 10 carbon atoms, or a chlorine atom.

Preferably, the fluorocopolymer (A) comprises, as the structural unit (A2), a structural unit derived from a phenolic hydroxyl-containing monomer.

Preferably, the fluorocopolymer (A) further comprises a silicon atom, particularly a siloxane structure represented by formula (3).

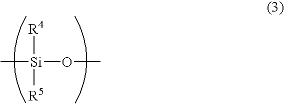

In the formula, R⁴ and R⁵ each independently represent a hydrogen atom, an alkyl group or a halogenated alkyl group having 1 to 10 carbon atoms, or an aryl group having 6 to 20 carbon atoms.

The copolymer (A) having a fluorine atom in its molecule used in the present invention can be produced, for example, by copolymerizing

at least one monomer (a1) selected from fluoro(meth)acrylic esters, fluoroolefins, and fluoroolefin derivatives,

at least one monomer (a2) selected from hydroxyl-containing monomers, epoxy-containing monomers, and carboxyl-containing monomers, and

if necessary, at least one monomer (a3) selected from vinyl compounds, (meth)acrylic esters, unsaturated carboxylic acid esters, (meth)acrylamides, and unsaturated nitriles. Further, in the copolymerization, a reactive emulsifier may be used.

Further, regarding the fluorocopolymer (A), a monomer (a4) comprising a silicon atom, particularly a siloxane structure may be further reacted to produce a silicon-containing fluorocopolymer (A)

(a1) Monomer:

The monomer (a1) used in the present invention is a compound containing a polymerizable unsaturated double bond and at least one fluorine atom, and examples thereof include fluoro(meth)acrylic esters, fluoroolefins, and fluoroolefin derivatives.

Examples of fluoro(meth)acrylic esters include trifluoroethyl(meth)acrylate and hexafluoroisopropyl (meth)acrylate.

Examples of fluoroolefins include tetrafluoroethylene, hexafluoropropylene, 3,3,3-trifluoropropylene, and chlorotrifluoroethylene.

Examples of fluoroolefin derivatives include: alkyl perfluorovinyl ethers such as methyl trifluorovinyl ether and ethyl trifluorovinyl ether; alkoxyalkyl perfluorovinyl ethers such as methoxyethyl trifluorovinyl ether and ethoxyethyl trifluorovinyl ether; perfluoro(alkyl vinyl ethers) such as perfluoro(methyl vinyl ether), perfluoro(ethyl vinyl ether), perfluoro(propyl vinyl ether), perfluoro(butyl vinyl ether), and perfluoro(isobutyl vinyl ether); and perfluoro(alkoxyalkyl vinyl ethers) such as perfluoro(propoxypropyl vinyl ether).

These compounds may be used solely or as a mixture of two or more of them.

The structural unit (A1), derived from this monomer (a1), is desirably contained in the fluorocopolymer (A) in an amount of generally 1 to 90% by weight, preferably 5 to 85% by weight, more preferably 10 to 70% by weight. When the content of the structural unit (A1) is below the lower limit of the above-defined content range, the content of fluorine in the fluorocopolymer (A) is likely to be excessively low and, in this case, the anti-fouling properties of a cured product obtained by curing the photosensitive fluororesin composition are sometimes unsatisfactory. On the other hand, when the content of the structural unit (A1) is above the upper limit of the above-defined content range, in some cases, the solubility of the fluorocopolymer (A) in an organic solvent is significantly lowered and, at the same time, the transparency of a cured product obtained by curing the photosensitive fluororesin composition and the adhesion to the base material are reduced.

(a2) Monomer:

The monomer (a2) used in the present invention is a monomer copolymerizable with the monomer (a1) and containing at least one substituent selected from hydroxyl, epoxy and carboxyl groups.

Examples of hydroxyl-containing monomers include hydroxyl-containing vinyl ethers such as hydroxyethyl vinyl ether and hydroxybutyl vinyl ether; hydroxyl-containing (meth)acrylic esters such as hydroxyethyl (meth)acrylate; and phenolic hydroxyl-containing monomers such as p-hydroxystyrene, m-hydroxystyrene, o-hydroxystyrene, p-isopropenylphenol, m-isopropenylphenol, and o-isopropenylphenol.

Further, in the present invention, the fluorocopolymer (A) may be produced by using a monomer given by protecting the hydroxyl group the hydroxystyrene, for example, with a t-butyl group or an acetoxy group. Specifically, a fluorocopolymer (A) comprising a structural unit derived from hydroxystyrene is obtained by copolymerizing the monomer (a1) with a hydroxystyrene compound with the hydroxyl group being protected and deprotecting the resultant copolymer by a conventional method such as deprotection in the presence of an acid catalyst.

Examples of epoxy-containing monomers include epoxy-containing vinyl ethers such as glycidyl vinyl ether; and epoxy-containing (meth)acrylic esters such as glycidyl(meth)acrylate.

Examples of carboxyl-containing monomers include unsaturated carboxylic acids such as (meth)acrylic acid, crotonic acid, itaconic acid, maleic acid, and fumaric acid.

These compounds may be used solely or as a mixture of two or more of them.

The structural unit (A2), derived from this monomer (a2), is desirably contained in the fluorocopolymer (A) in an amount of generally 2 to 80% by weight, preferably 5 to 75% by weight, more preferably 10 to 60% by weight. When the content of the structural unit (A2) is below the lower limit of the above-defined content range, the patternability of the photosensitive fluororesin composition is unsatisfactory. On the other hand, when the content of the structural unit (A2) is above the upper limit of the above-defined content range, the water resistance of a cured product obtained by curing the photosensitive fluororesin composition is likely to be lowered.

(a3) Monomer:

The monomer (a3) used in the present invention is not particularly limited so far as it is copolymerizable with the monomer (a1) and/or the monomer (a2). Examples of the monomer (a3) include vinyl compounds, (meth)acrylic esters, unsaturated carboxylic acid esters, (meth)acrylamides, and unsaturated nitriles.

Examples of vinyl compounds include:

alkyl vinyl ethers or cycloalkyl vinyl ethers such as methyl vinyl ether, ethyl vinyl ether, n-propyl vinyl ether, isopropyl vinyl ether, n-butyl vinyl ether, isobutyl vinyl ether, tert-butyl vinyl ether, n-pentyl vinyl ether, n-hexyl vinyl ether, n-octyl vinyl ether, n-dodecyl vinyl ether, lauryl vinyl ether, cetyl vinyl ether, 2-ethylhexyl vinyl ether, and cyclohexyl vinyl ether;

carboxylic acid vinyl esters such as vinyl acetate, vinyl propionate, vinyl butyrate, vinyl pivalate, vinyl caproate, vinyl versatate, vinyl stearate, and benzoic acid;

α-olefins such as ethylene, propylene, and isobutene; and

aromatic vinyl compounds such as styrene, α-methylstyrene, o-methylstyrene, m-methylstyrene, p-methylstyrene, p-tert-butylstyrene, diisopropenylbenzene, o-chlorostyrene, m-chlorostyrene, p-chlorostyrene, 1,1-diphenylethylene, p-methoxystyrene, N,N-dimethyl-p-aminostyrene, N,N-diethyl-p-aminostyrene, vinylpyridine, and vinylimidazole.

Examples of (meth)acrylic esters include:

alkyl(meth)acrylates such as methyl (meth)acrylate, ethyl(meth)acrylate, propyl (meth)acrylate, isopropyl(meth)acrylate, butyl (meth)acrylate, isobutyl(meth)acrylate, tert-butyl (meth)acrylate, pentyl(meth)acrylate, amyl (meth)acrylate, isoamyl(meth)acrylate, hexyl (meth)acrylate, heptyl(meth)acrylate, octyl (meth)acrylate, isooctyl(meth)acrylate, 2-ethylhexyl (meth)acrylate, nonyl(meth)acrylate, decyl (meth)acrylate, isodecyl(meth)acrylate, undecyl (meth)acrylate, dodecyl(meth)acrylate, lauryl (meth)acrylate, stearyl(meth)acrylate, and isostearyl (meth)acrylate;

phenoxyalkyl(meth)acrylates such as phenoxyethyl (meth)acrylate and 2-hydroxy-3-phenoxypropyl (meth)acrylate; alkoxyalkyl(meth)acrylates such as methoxyethyl (meth)acrylate, ethoxyethyl(meth)acrylate,

propoxyethyl(meth)acrylate, butoxyethyl (meth)acrylate, and methoxybutyl(meth)acrylate; polyethylene glycol (meth)acrylates such as polyethylene glycol mono(meth)acrylate, ethoxydiethylene glycol (meth)acrylate, methoxypolyethylene glycol (meth)acrylate, phenoxypolyethylene glycol (meth)acrylate, and nonylphenoxy polyethylene glycol (meth)acrylate; polypropylene glycol (meth)acrylates such as polypropylene glycol mono(meth)acrylate, methoxy polypropylene glycol (meth)acrylate, ethoxy polypropylene glycol (meth)acrylate, and nonylphenoxy polypropylene glycol (meth)acrylate;

cycloalkyl(meth)acrylates such as cyclohexyl (meth)acrylate, 4-butyl cyclohexyl(meth)acrylate, dicyclopentanyl(meth)acrylate, dicyclopentenyl (meth)acrylate, dicyclopentadienyl(meth)acrylate, bornyl(meth)acrylate, isobornyl(meth)acrylate, and tricyclodecanyl(meth)acrylate;

benzyl(meth)acrylate; and

tetrahydrofurfuryl(meth)acrylate.

Examples of (meth)acrylamides include acryloyl morpholine, diacetone (meth)acrylamide, isobutoxymethyl(meth)acrylamide, dimethylaminoethyl (meth)acrylamide, diethylaminoethyl(meth)acrylamide, dimethylaminopropyl(meth)acrylamide, tert-octyl (meth)acrylamide, 7-amino-3,7-dimethyloctyl (meth)acrylamide, N,N-dimethyl(meth)acrylamide, and N,N-diethyl(meth)acrylamide.

Examples of unsaturated carboxylic acid esters include methyl crotonate, ethyl crotonate, propyl crotonate, butyl crotonate, methyl cinnamate, ethyl cinnamate, propyl cinnamate, butyl cinnamate, dimethyl itaconate, diethyl itaconate, dimethyl maleate, diethyl maleate, dimethyl fumarate, and diethyl fumarate.

Examples of unsaturated nitriles include (meth)acrylonitrile, α-chloro acrylonitrile, α-chloromethyl acrylonitrile, α-methoxy acrylonitrile, α-ethoxy acrylonitrile, crotonic acid nitrile, cinnamic acid nitrile, itaconic acid dinitrile, maleic acid dinitrile, and fumaric acid dinitrile.

These compounds may be used solely or as a mixture of two or more of them.

The structural unit (A3), derived from this monomer (a3), is desirably contained in the fluorocopolymer (A) in an amount of generally 1 to 90% by weight, preferably 5 to 80% by weight, more preferably 10 to 70% by weight. When the content of the structural unit (A3) is below the lower limit of the above-defined content range, in some cases, the type of the solvent which may be used is restricted. On the other hand, when the content of the structural unit (A3) is above the upper limit of the above-defined content range, the patternability of the photosensitive fluororesin composition is unsatisfactory, and, in addition, the water resistance of a cured product obtained by curing the photosensitive fluororesin composition is likely to be lowered.

(a4) Monomer:

The monomer (a4) used in the present invention is not particularly limited so far as it contains a silicon atom and is copolymerizable with at least one of the monomers (a1) to (a3). However, a compound which can introduce a siloxane structure into the fluorocopolymer (A) is preferred, and examples thereof include azo-containing polysiloxane compounds. The azo-containing polysiloxane compounds are compounds containing an easily heat-cleavable azo group represented by —N═N— and may be produced, for example, by a method described in Japanese Patent Laid-Open No. 6-93100/1994. Specific examples thereof include compounds having the following structure. 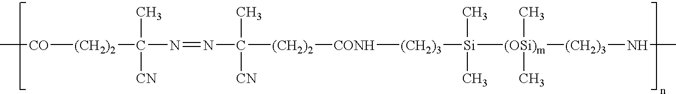
wherein m is 0 or an integer of 1 to 200, and n is an integer of 1 to 50.

Commercially available products such as “VPS-0501” and “VPS-1001” (these products being manufactured by Wako Pure Chemical Industries, Ltd.) may also be used.

This azo-containing polysiloxane compound is also a heat radical generator and serves also as a polymerization initiator in a copolymerization reaction for producing the fluorocopolymer (A). In this case, this azo-containing polysiloxane compound and other radical polymerization initiator may be used in combination.

The siloxane structure is desirably contained in the fluorocopolymer (A) in an amount of generally 0 to 20% by weight, preferably 0.1 to 15% by weight, more preferably 0.1 to 10% by weight. When the content of the siloxane structure is below the lower limit of the above-defined content range, in some cases, the anti-fouling properties of a cured product produced by curing the photosensitive fluororesin composition are unsatisfactory. On the other hand, when the content of the siloxane structure is above the upper limit of the above-defined content range, the adhesion of a cured product produced by curing the photosensitive fluororesin composition to the base material is lowered, or repelling or the like is likely to occur during coating of the coating material.

Reactive Emulsifier:

The fluorocopolymer (A) used in the present invention may comprise a structural unit (A5) derived from a reactive emulsifier. The reactive emulsifier is preferably a nonionic reactive emulsifier. Nonionic reactive emulsifiers include, for example, compounds represented by formula (4)

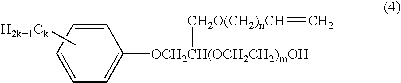

In the formula, k=1 to 20, m=0 to 4, and n 3 to 50.

In the present invention, commercially available products, for example, “ADEKA REASOAP NE-S,” “ADEKA REASOAP NE-10,” “ADEKA REASOAP NE-20,” “ADEKA REASOAP NE-30,” and “ADEKA REASOAP NE-40” (all of these products being manufactured by Asahi Denka Co., Ltd.) may be used as the nonionic reactive emulsifier.

The structural unit (A5) is desirably contained in the fluorocopolymer (A) in an amount of generally 0 to 10% by weight, preferably 0.01 to 5% by weight, more preferably 0.05 to 2% by weight. When the content of the structural unit (A5) falls within the above-defined content range, the photosensitive fluororesin composition, when used as a coating agent, has good coatability and leveling properties. When the content of the structural unit (A5) is below the lower limit of the above-defined content range, repelling or the like is likely to occur at the time of coating of the coating agent. On the other hand, when the content of the structural unit (A5) is above the upper limit of the above-defined content range, the photosensitive fluororesin composition is likely to become sticky and thus is difficult to handle. Therefore, when this composition is used as a coating agent, the moisture resistance is lowered.

(Polymerization of Fluorocopolymer (A))

The fluorocopolymer (A) used in the present invention can be synthesized by using the monomers (a1) and (a2) and optionally the monomer (a3) and/or the monomer (a4). Further, if necessary, a reactive emulsifier may be used. Preferred combinations of the monomers (a1) to (a4) are as follows:

(1) combination of monomers (a1) and (a2):

for example,

fluoroolefin/hydroxyl-containing vinyl ether,

fluoroolefin/epoxy-containing vinyl ether,

fluoroolefin/unsaturated carboxylic acid,

fluoroolefin and perfluoro(alkyl vinyl ether)/hydroxyl-containing vinyl ether,

fluoro(meth)acrylic ester/hydroxyl-containing (meth)acrylic ester,

fluoro(meth)acrylic ester/phenolic hydroxyl-containing monomer,

fluoro(meth)acrylic ester/epoxy-containing (meth)acrylic ester,

fluoro(meth)acrylic ester/unsaturated carboxylic acid,

fluoro(meth)acrylic ester/hydroxyl-containing (meth)acrylic ester and unsaturated carboxylic acid, and

fluoro(meth)acrylic ester/phenolic hydroxyl-containing monomer and unsaturated carboxylic acid;

(2) combinations of monomers (a1), (a2) and (a3):

for example,

fluoroolefin/hydroxyl-containing vinyl ether/alkyl vinyl ehter,

fluoroolefin/epoxy-containing vinyl ether/alkyl vinyl ehter,

fluoroolefin/unsaturated carboxylic acid/alkyl vinyl ehter,

fluoroolefin and perfluoro(alkyl vinyl ether)/hydroxyl-containing vinyl ether/alkyl vinyl ehter,

fluoro(meth)acrylic ester/hydroxyl-containing (meth)acrylic ester/(meth)acrylic ester,

fluoro(meth)acrylic ester/phenolic hydroxyl-containing monomer/(meth)acrylic ester,

fluoro(meth)acrylic ester/epoxy-containing (meth)acrylic ester/(meth)acrylic ester,

fluoro(meth)acrylic ester/unsaturated carboxylic acid/(meth)acrylic ester,

fluoro(meth)acrylic ester/hydroxyl-containing (meth)acrylic ester and unsaturated carboxylic acid/(meth)acrylic ester, and

fluoro(meth)acrylic ester/phenolic hydroxyl-containing monomer and unsaturated carboxylic acid/(meth)acrylic ester;

(3) combinations of monomers (a1), (a2) and (a4):

for example,

fluoroolefin/hydroxyl-containing vinyl ether/azo-containing polydimethylsiloxane,

fluoroolefin/epoxy-containing vinyl ether/azo-containing polydimethylsiloxane,

fluoroolefin/unsaturated carboxylic acid/azo-containing polydimethylsiloxane,

fluoroolefin and perfluoro(alkyl vinyl ether)/hydroxyl-containing vinyl ether/azo-containing polydimethylsiloxane,

fluoro(meth)acrylic ester/hydroxyl-containing (meth)acrylic ester/azo-containing polydimethylsiloxane,

fluoro(meth)acrylic ester/phenolic hydroxyl-containing monomer/azo-containing polydimethylsiloxane,

fluoro(meth)acrylic ester/epoxy-containing (meth)acrylic ester/azo-containing polydimethylsiloxane,

fluoro(meth)acrylic ester/unsaturated carboxylic acid/azo-containing polydimethylsiloxane,

fluoro(meth)acrylic ester/hydroxyl-containing (meth)acrylic ester and unsaturated carboxylic acid/azo-containing polydimethylsiloxane, and

fluoro(meth)acrylic ester/phenolic hydroxyl-containing monomer and unsaturated carboxylic acid/azo-containing polydimethylsiloxane; and

(4) combinations of monomers (a1), (a2), (a3) and (a4):

for example,

fluoroolefin/hydroxyl-containing vinyl ether/alkyl vinyl ehter/azo-containing polydimethylsiloxane,

fluoroolefin/epoxy-containing vinyl ether/alkyl vinyl ehter/azo-containing polydimethylsiloxane,

fluoroolefin/unsaturated carboxylic acid/alkyl vinyl ehter/azo-containing polydimethylsiloxane,

fluoroolefin and perfluoro(alkyl vinyl ether)/hydroxyl-containing vinyl ether/alkyl vinyl ehter/azo-containing polydimethylsiloxane,

fluoro(meth)acrylic ester/hydroxyl-containing (meth)acrylic ester/(meth)acrylic ester/azo-containing polydimethylsiloxane,

fluoro(meth)acrylic ester/phenolic hydroxyl-containing monomer/(meth)acrylic ester/azo-containing polydimethylsiloxane,

fluoro(meth)acrylic ester/epoxy-containing (meth)acrylic ester/(meth)acrylic ester/azo-containing polydimethylsiloxane,

fluoro(meth)acrylic ester/unsaturated carboxylic acid/(meth)acrylic ester/azo-containing polydimethylsiloxane,

fluoro(meth)acrylic ester/hydroxyl-containing (meth)acrylic ester and unsaturated carboxylic acid/(meth)acrylic ester/azo-containing polydimethylsiloxane, and

fluoro(meth)acrylic ester/phenolic hydroxyl-containing monomer and unsaturated carboxylic acid/(meth)acrylic ester/azo-containing polydimethylsiloxane.

The fluorocopolymer (A) used in the present invention may be prepared by any polymerization method so far as a radical polymerization initiator is used, for example, emulsion polymerization, suspension polymerization, bulk polymerization, or solution polymerization. The polymerization operation type can be properly selected, for example, from batch, semi-continuous and continuous types. Conditions for polymerization are not particularly limited. Preferably, however, the polymerization is carried out at a temperature, for example, in the range of 50 to 200° C. for 1 to 100 hr.

Radical polymerization initiators include, for example,

diacyl peroxides such as acetyl peroxide and benzoyl peroxide;

ketone peroxides such as methyl ethyl ketone peroxide and cyclohexanone peroxide;

hydroperoxides such as hydrogen peroxide, tert-butylhydroperoxide, and cumene hydroperoxide;

dialkyl peroxides such as di-tert-butyl peroxide, dicumylperoxide, and dilauroyl peroxide;

peroxy esters such as tert-butyl peroxyacetate, and tert-butyl peroxypivalate;

azo compounds such as azobisisobutyronitrile and azobisisovaleronitrile; and

persulfates such as ammonium persulfate, sodium persulfate, and potassium persulfate.

Preferably, the fluorocopolymer (A) is polymerized in a solvent. Solvents usable herein include, for example,

aliphatic hydrocarbon solvents such as n-pentane, i-pentane, n-hexane, i-hexane, n-heptane, i-heptane, 2,2,4-trimethylpentane, n-octane, i-octane, cyclohexane, and methylcyclohexane;

aromatic hydrocarbon solvents such as benzene, toluene, xylene, ethylbenzene, trimethylbenzene, methylethylbenzene, n-propylbenzene, i-propylbenzene, diethylbenzene, i-butylbenzene, triethylbenzene, di-i-propylbenzene, n-amyl naphthalene, and trimethylbenzene;

monoalcohol solvents such as methanol, ethanol, n-propanol, i-propanol, n-butanol, i-butanol, sec-butanol, t-butanol, n-pentanol, i-pentanol, 2-methylbutanol, sec-pentanol, t-pentanol, 3-methoxybutanol, n-hexanol, 2-methylpentanol, sec-hexanol, 2-ethylbutanol, sec-heptanol, heptanol-3, n-octanol, 2-ethylhexanol, sec-octanol, n-nonyl alcohol, 2,6-dimethylheptanol-4, n-decanol, sec-undecyl alcohol, trimethylnonyl alcohol, sec-tetradecylalcohol, sec-heptadecylalcohol, phenol, cyclohexanol, methylcyclohexanol, 3,3,5-trimethylcyclohexanol, benzyl alcohol, phenylmethylcarbinol, diacetone alcohol, and cresol;

polyhydric alcohol solvents such as ethylene glycol, 1,2-propylene glycol, 1,3-butylene glycol, pentanediol-2,4,2-methylpentanediol-2,4, hexanediol-2,5, heptanediol-2,4,2-ethylhexanediol-1,3, diethylene glycol, dipropylene glycol, triethylene glycol, tripropylene glycol, and glycerin;

ketone solvents such as acetone, methyl ethyl ketone, methyl-n-propylketone, methyl-n-butylketone, diethyl ketone, methyl-1-butyl ketone, methyl-n-pentyl ketone, ethyl-n-butyl ketone, methyl-n-hexyl ketone, di-1-butyl ketone, trimethylnonanone, cyclohexanone, methylcyclohexanone, 2,4-pentanedione, acetonylacetone, diacetone alcohol, acetophenone, and fenchone;

ether solvents such as ethyl ether, i-propyl ether, n-butyl ether, n-hexyl ether, 2-ethylhexyl ether, ethylene oxide, 1,2-propylene oxide, dioxolane, 4-methyl dioxolane, dioxane, dimethyl dioxane, ethylene glycol monomethyl ether, ethylene glycol monoethyl ether, ethylene glycol diethyl ether, ethylene glycol mono-n-butyl ether, ethylene glycol mono-n-hexyl ether, ethylene glycol monophenyl ether, ethylene glycol mono-2-ethyl butyl ether, ethylene glycol dibutyl ether, diethylene glycol monomethyl ether, diethylene glycol monoethyl ether, diethylene glycol diethyl ether, diethylene glycol mono-n-butyl ether, diethylene glycol di-n-butyl ether, diethylene glycol mono-n-hexyl ether, ethoxytriglycol, tetraethylene glycol di-n-butyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, tripropylene glycol monomethyl ether, tetrahydrofuran, and 2-methyltetrahydrofuran;

ester solvents such as diethyl carbonate, methyl acetate, ethyl acetate, γ-butyrolactone, γ-valerolactone, n-propyl acetate, i-propyl acetate, n-butyl acetate, i-butyl acetate, sec-butyl acetate, n-pentyl acetate, sec-pentyl acetate, 3-methoxy butyl acetate, methyl pentyl acetate, 2-ethyl butyl acetate, 2-ethylhexyl acetate, benzyl acetate, cyclohexyl acetate, methylcyclohexyl acetate, n-nonyl acetate, methyl acetoacetate, ethyl acetoacetate, ethylene glycol monomethyl ether acetate, ethylene glycol monoethyl ether acetate, diethylene glycol monomethyl ether acetate, diethylene glycol monoethyl ether acetate, diethylene glycol mono-n-butyl ether acetate, propylene glycol monomethyl ether acetate, propylene glycol monoethyl ether acetate, propylene glycol monopropyl ether acetate, propylene glycol monobutyl ether acetate, dipropylene glycol monomethyl ether acetate, dipropylene glycol monoethyl ether acetate, glycol diacetate, methoxytriglycol acetate, ethyl propionate, n-butyl propionate, i-amyl propionate, diethyl oxalate, di-n-butyl oxalate, methyl lactate, ethyl lactate, n-butyl lactate, n-amyl lactate, diethyl malonate, dimethyl phthalate, and diethyl phthalate;

nitrogen-containing solvents such as N-methylformamide, N,N-dimethylformamide, N,N-diethylformamide, acetamide, N-methylacetamide, N,N-dimethylacetamide, N-methylpropionamide, and N-methylpyrrolidone; and

sulfur-containing solvents such as dimethyl sulfide, diethyl sulfide, thiophene, tetrahydrothiophene, dimethyl sulfoxide, sulfolane, and 1,3-propane sultone. They may be used solely or as a mixture of two or more of them.

The reaction solution containing the fluorocopolymer (A) prepared by the above polymerization method as such may be used as a raw material for the photosensitive fluororesin composition. Alternatively, this reaction solution may be used after proper post treatment. Regarding the post treatment, for example, after reprecipitation treatment, the purified fluorocopolymer (A) may be dissolved in a solvent. An example of the reprecipitation treatment is purification treatment in which the reaction solution is added dropwise to an insolubilizing solvent for the fluorocopolymer (A), such as alcohols, to coagulate the fluorocopolymer (A) Further, the removal of the residual monomer from the resultant reaction solution may be carried out as the post treatment.

The molecular weight of the fluorocopolymer (A) used in the present invention is not particularly limited. However, the weight average molecular weight (Mw) as determined by gel permeation chromatography (GPC) is generally not more than 200,000, preferably 5,000 to 100,000, in terms of polystyrene. When the weight average molecular weight is excessively small, properties such as heat resistance and elongation of a cured product produced by curing the photosensitive fluororesin composition are deteriorated. On the other hand, when the weight average molecular weight is excessively large, a deterioration in compatibility with other component in the photosensitive fluororesin composition or a deterioration in patternability of the photosensitive fluororesin composition sometimes occurs. In the present invention, the fluorocopolymer (A) is used in an amount of 5 to 70% by weight, preferably 10 to 60% by weight, based on the total amount of the photosensitive fluororesin composition.

(B) Compound Containing at Least Two Alkyletherized Amino Groups in its Molecule:

The compound containing at least two alkyletherized amino groups in its molecule (hereinafter referred to as “crosslinking agent (B)”) used in the present invention is a compound which can form a cured product through a reaction with the fluorocopolymer (A) and/or a phenolic resin (E) which will be described later.

An example of the above crosslinking agents (B) is a nitrogen-containing compound prepared by alkyletherizing all or a part of active methylol groups in (poly)methylolated melamine, (poly)methylolated glycoluryl, (poly)methylolated benzoguanamine, (poly)methylolated urea or the like. Examples of alkyl groups include methyl, ethyl, and butyl groups and a combination of these groups.

The crosslinking agent (B) may contain an oligomer component prepared by self-condensation of a part of a compound containing two or more alkyletherized amino groups in its molecule.

Specific examples of the crosslinking agent (B) include hexamethoxymethylated melamine, hexabutoxymethylated melamine, tetramethoxymethylated glycoluryl, and tetrabutoxymethylated glycoluryl. These crosslinking agents may be used solely or as a mixture of two or more of them.

This crosslinking agent (B) is used in an amount of 1 to 200 parts by weight, preferably 5 to 100 parts by weight, based on 100 parts by weight in total of the fluorocopolymer (A) and the phenolic resin (E). When the amount of the crosslinking agent (B) incorporated is below the lower limit of the above-defined amount range, curing of the photosensitive fluororesin composition upon exposure is unsatisfactory. In this case, further, in some cases, a deterioration in patterning properties of the photosensitive fluororesin composition or a deterioration in scratch resistance of a cured product produced by curing the photosensitive fluororesin composition occurs. On the other hand, when the amount of the crosslinking agent (B) incorporated is above the upper limit of the above-defined amount range, the resolution of the photosensitive fluororesin composition is likely to be lowered.

(C) Photosensitive Acid Generating Agent:

The photosensitive acid generating agent (C) used in the present invention is a compound which generates an acid upon exposure to a radiation or the like. This acid can catalytically act to crosslink the alkyl ether group in the crosslinking agent (B) with the fluorocopolymer (A) and/or a phenol ring in the phenolic resin (E) through an dealcoholization reaction and thus to form a negative-working pattern.

The photosensitive acid generating agent (C) may be any compound without particular limitation so far as the compound generates an acid upon exposure to a radiation or the like, and examples thereof include onium salt compounds, halogen-containing compounds, diazo ketone compounds, sulfone compounds, sulfonic acid compounds, sulfonimide compounds, and diazomethane compounds.

Onium salts compounds include, for example, iodonium salts, sulfonium salts, phosphonium salts, diazonium salts, and pyridinium salts. Among such onium salts, specifically preferred compounds include diphenyliodonium trifluoromethanesulfonate, diphenyliodonium p-toluenesulfonate, diphenyliodonium hexafluoroantimonate, diphenyliodonium hexafluorophosphate, diphenyliodonium tetrafluoroborate, triphenylsulfonium trifluoromethanesulfonate, triphenylsulfonium p-toluenesulfonate, triphenylsulfonium hexafluoroantimonate, 4-t-butylphenyl-diphenylsulfonium trifluoromethanesulfonate, 4-t-butylphenyl-diphenylsulfonium p-toluenesulfonate, and 4,7-di-n-butoxynaphthyl tetrahydrothiophenium trifluoromethanesulfonate.

Halogen-containing compounds include, for example, haloalkyl-containing hydrocarbon compounds and haloalkyl-containing heterocyclic compounds. Among such halogen-containing compounds, specifically preferred compounds include s-triazine derivatives such as 1,10-dibromo-n-decane, 1,1-bis(4-chlorophenyl)-2,2,2-trichloroethane, phenyl-bis(trichloromethyl)-s-triazine, 4-methoxyphenyl-bis (trichloromethyl)-s-triazine, styryl-bis(trichloromethyl)-s-triazine, and naphthyl-bis (trichloromethyl)-s-triazine.

Diazoketone compounds include, for example, 1,3-diketo-2-diazo compounds, diazobenzoquinone compounds, and diazonaphthoquinone compounds. Among such diazoketone compounds, specifically preferred compounds include 1,2-naphthoquinonediazido-4-sulfonic ester compounds of phenols.

Sulfone compounds include, for example, β-ketosulfone compounds, β-sulfonylsulfone compounds, and α-diazo compounds of these compounds. Among such sulfone compounds, specifically preferred compounds include 4-trisphenacylsulfone, mesitylphenacylsulfone, and bis(phenacylsulfonyl)methane.

Sulfonic acid compounds include, for example, alkylsulfonic esters, haloalkylsulfonic esters, arylsulfonic esters, and iminosulfonates. Among such sulfonic acid compounds, specifically preferred compounds include benzoin tosylate, pyrogallol tristrifluoromethanesulfonate, o-nitrobenzyl trifluoromethanesulfonate, and o-nitrobenzyl p-toluenesulfonate.

Specific examples of sulfonimide compounds include N-(trifluoromethylsulfonyloxy)succinimide, N-(trifluoromethylsulfonyloxy)phthalimide, N-(trifluoromethylsulfonyloxy)diphenylmaleimide, N-(trifluoromethylsulfonyloxy)bicyclo[2.2.1]hept-5-ene-2,3-dicarboxyimide, and N-(trifluoromethylsulfonyloxy)naphthylimide.

Specific examples of diazomethane compounds include bis(trifluoromethylsulfonyl)diazomethane, bis(cyclohexylsulfonyl)diazomethane, and bis(phenylsulfonyl) diazomethane.

Such acid generating agents (C) may be used solely or as a mixture of two or more of them. From the viewpoint of ensuring the sensitivity and resolution of the photosensitive fluororesin composition, pattern shape and the like, the amount of the acid generating agent (C) incorporated is generally 0.1 to 10 parts by weight, preferably 0.3 to 5 parts by weight, based on 100 parts by weight in total of the fluorocopolymer (A), the crosslinking agent (B), and the phenolic resin (E). In this case, when the amount of the acid generating agent (C) incorporated is below the lower limit of the above-defined amount range, curing of the photosensitive fluororesin composition is unsatisfactory and, in some case, the heat resistance is lowered. On the other hand, when the amount of the acid generating agent (C) incorporated is above the upper limit of the above-defined amount range, the transparency of the photosensitive fluororesin composition to a radiation is lowered, leading to a fear of causing a deteriorated pattern shape.

(D) Solvent:

The solvent (D) used in the present invention is added in a proper amount in order to improve the handleabiltiy of the photosensitive fuororesin composition or to regulate the viscosity or storage stability. The solvent (D) may be any organic solvent without particular limitation so far as the object of the present invention is not sacrificed. Examples thereof include:

ethylene glycol monoalkyl ether acetates such as ethylene glycol monomethyl ether acetate and ethylene glycol monoethyl ether acetate;

propylene glycol monoalkyl ethers such as propylene glycol monomethyl ether, propylene glycol monoethyl ether, propylene glycol monopropyl ether, and propylene glycol monobutyl ether;

propylene glycol dialkyl ethers such as propylene glycol dimethyl ether, propylene glycol diethyl ether, propylene glycol dipropyl ether, and propylene glycol dibutyl ether;

propylene glycol monoalkyl ether acetates such as propylene glycol monomethyl ether acetate, propylene glycol monoethyl ether acetate, propylene glycol monopropyl ether acetate, and propylene glycol monobutyl ether acetate;

cellosolves such as ethylcellosolve and butylcellosolve;

carbitols such as butyl carbitol; lactic esters such as methyl lactate, ethyl lactate, n-propyl lactate, and isopropyl lactate;

aliphatic carboxylic acid esters such as ethyl acetate, n-propyl acetate, isopropyl acetate, n-butyl acetate, isobutyl acetate, n-amyl acetate, isoamyl acetate, isopropyl propionate, n-butyl propionate, and isobutyl propionate;

esters such as methyl 3-methoxy propionate, ethyl 3-methoxy propionate, methyl 3-ethoxy propionate, ethyl 3-ethoxy propionate, methylpyruvate, and ethyl pyruvate;

aromatic hydrocarbons such as toluene and xylene;

ketones such as 2-heptanone, 3-heptanone, 4-heptanone, and cyclohexanone;

amides such as N-dimethylformamide, N-methyl acetamide, N,N-dimethyl acetamide, and N-methylpyrrolidone; and

lactones such as γ-butyrolactone.

These solvents (D) may be used solely or as a mixture of two or more of them.

(E) Phenolic Resin:

In the present invention, when the alkali solubility of the fluorocopolymer (A) is unsatisfactory, the fluorocopolymer (A) may be used in combination with a phenolic resin (E). Examples of such phenolic resins (E) include novolak resins, polyhydroxystyrene and copolymers thereof, and low-molecular phenol compounds. The amount of the phenolic resin (E) incorporated may be properly determined so that the photosensitive fluororesin composition can exert satisfactory alkali solubility. Specifically, the phenolic resin (E) may be used in an amount of 0 to 200 parts by weight based on 100 parts by weight of the fluorocopolymer (A). In this case, the patternability of the photosensitive fluororesin composition can be improved.

(F) Epoxy Compound:

Further, in the present invention, an oxirane ring-containing compound (hereinafter referred to as “epoxy compound (F)”) may also be used. The epoxy compound (F) is not particularly limited so far as an oxirane ring is contained within its molecule. Specific examples thereof include phenol novolak epoxy resins, cresol novolak epoxy resins, alicyclic epoxy resins, and aliphatic epoxy resins. The epoxy compound (F) is preferably used in an amount of 1 to 100 parts by weight, more preferably 5 to 50 parts by weight, based on 100 parts by weight in total of the fluorocopolymer (A) and the phenolic resin (E). In this case, the hardness and durability of the coating film can be improved.

(G) Other Additives:

The photosensitive fluororesin composition according to the present invention may contain other additives such as metal oxide fine particles, crosslinked fine particles, adhesion aids, sensitizers, leveling agents, and colorants.

In the present invention, the metal oxide fine particles and the crosslinked fine particles generally have a diameter of 5 to 500 nm, preferably 10 to 100 nm. The amount of these fine particles incorporated is preferably 0 to 50 parts by weight based on 100 parts by weight in total of the fluorocopolymer (A) and the crosslinking agent (B). When the amount of the fine particles incorporated exceeds 50 parts by weight, the strength and heat resistance of the coating film and compatibility with other components in the photosensitive fluororesin composition are lowered.

Metal oxide particles include, for example, SrTiO₃, FeTiO₃, WO₃, SnO₂, Bi₂O₃, In₂O₃, ZnO, Fe₂O₃, RuO₂, CdO, CdS, CdSe, GaP, GaAs, CdFeO₃, MoS₂, LaRhO₃, GaN, CdP, ZnS, ZnSe, ZnTe, Nb₂O₅, ZrO₂, InP, GaAsP, InGaAlP, AlGaAs, PbS, InAs, PbSe, InSb, SiO₂, Al₂O₃, AlGaAs, Al(OH)₃, Sb₂O₅, Si₃N₄, Sn—In₂O₃, Sb—In₂O₃, MgF, CeF₃, CeO₂, 3Al₂O₃.2SiO₂, BeO, SiC, AlN, Fe, Co, Co-FeOₓ, CrO₂, Fe₄N, BaTiO₃, BaO—Al₂O₃—SiO₂, Ba ferrite, SmCO₅, YCO₅, CeCO₅, PrCO₅, Sm₂CO₁₇, Nd₂Fe₁₄B, A1₄O₃, α-Si, SiN₄, CoO, Sb—SnO₂, Sb₂O₅, MnO₂, MnB, Co₃O₄, Co₃B, LiTaO₃, MgO, MgAl₂O₄, BeAl₂O₄, ZrSiO₄, ZnSb, PbTe, GeSi, FeSi₂, CrSi₂, CoSi₂, MnSi_{1.73}, Mg₂Si, β-B, BaC, BP, TiB₂, ZrB₂, HfB₂, Ru₂Si₃, TiO₂ (rutile- or anatase-type), TiO₃, PbTiO₃, Al₂TiO₅, Zn₂SiO₄, Zr₂SiO₄, 2MgO₂—Al₂O₃.5SiO₂, Nb₂O₅, Li₂O—Al₂O₃. 4SiO₂, Mg ferrite, Ni ferrite, Ni—Zn ferrite, Li ferrite, and Sr ferrite. The use of such metal oxide particles can lead to the control of optical properties such as refractive index and electric properties such as dielectricity, insulating properties, and electrical conductivity of a cured film produced by curing the photosensitive fluororesin composition.

Crosslinked fine particles can be produced, for example, by emulsion polymerization of a radical polymerizable monomer. Specific examples of crosslinked fine particles include fine particles of styrene/divinylbenzene copolymers and (meth)acrylic ester/polyfunctional (meth)acrylic ester copolymers.

Adhesion aids usable in the present invention include, for example, various silane coupling agents such as tetramethoxysilane, tetraethoxysilane, vinyltrimethoxysilane, vinyltriethoxysilane, 3-aminopropyltrimethoxysilane, 3 aminopropyltriethoxysilane, 2-hydroxyethyltrimethoxysilane, 2-hydroxyethyltriethoxysilane, 3-mercaptopropyltrimethoxysilane, 3-mercaptopropyltriethoxysilane, 3-isocyanatopropyltrimethoxysilane, 3-isocyanatopropyltriethoxysilane, 3-glycidoxypropyltrimethoxysilane, 3-glycidoxypropyltriethoxysilane, 3-(meth)acryloxypropyltrimethoxysilane, and 3-(meth)acryloxypropyltriethoxysilane. The use of these adhesion aids can improve the tackiness and adhesion to a substrate of a cured film produced by curing the photosensitive fluororesin composition.

(Photosensitive Fluororesin Composition)

The photosensitive fluororesin composition according to the present invention comprises the fluorocopolymer (A), the crosslinking agent (B), the photosensitive acid generating agent (C), the solvent (D), and optionally the phenolic resin (E), the epoxy compound (F), the reactive emulsifier, and other additives. The cured product produced by curing the photosensitive fluororesin composition is excellent in the prevention of adherence or wiping-off properties of a water repellent oil component, finger prints and the like, as well as in thermal shock resistance, adhesion or other properties. The photosensitive fluororesin composition is also excellent in patternability by alkali development.

Since the photosensitive fluororesin composition according to the present invention has the above properties, it is suitable for use as surface protective films for displays, semiconductor elements and the like.

<Cured Film of Photosensitive Fluororesin>

(Production Process of Cured Film)

The cured film according to the present invention can be produced using the photosensitive fluororesin composition, for example, by the following method.

The photosensitive fluororesin composition according to the present invention is coated on a support (for example, a copper foil with a resin, a copper-clad laminated plate, a metal sputtered silicon wafer or alumina substrate, a glass plate, or a plastic plate). The coating is dried to volatilize the solvent and the like to form a coating film. Thereafter, the coating film is exposed through a desired mask pattern and is heat treated (this heat treatment being hereinafter referred to as “PEB”) to accelerate the reaction of the fluorocopolymer (A) with the crosslinking agent (B). Next, development is carried out with an alkali developing solution to dissolve and remove the unexposed areas, thereby forming a desired pattern. Further, in order to exert anti-fouling properties and the like, heat treatment is carried out to form a cured film such as an anti-fouling film. When patterning is unnecessary, whole area may be exposed without any mask, followed by heat treatment.

Methods usable for coating of the photosensitive fluororesin composition onto a support include coating methods, for example, dipping, spraying, bar coating, roll coating, or spin coating. The thickness of the coating may be properly regulated by regulating coating means and the solid content and viscosity of the composition solution.

Radiations usable for exposure include light with irradiation light wavelengths 300 nm to 500 nm emitted from exposure light sources, for example, low-pressure mercury lamps, high-pressure mercury lamps, metal halide lamps, g-radiation steppers, i-radiation steppers or other ultraviolet, electron beam or laser beam sources. The exposure may be properly determined depending upon the light source used, resin film thickness and the like. For example, in the case of ultraviolet irradiation from high-pressure mercury lamps, when the resin film thickness is 1 to 50 μm, the exposure is preferably about 1,000 to 50,000 J/m².

After the exposure, heating (PEB) treatment is carried out in order to accelerate a curing reaction between the fluorocopolymer (A) and the crosslinking agent (B) through the action of an acid generated from the photosensitive acid generating agent (C). Conditions for the heat treatment are properly determined by taking into consideration, for example, the mixing amount of the photosensitive fluororesin composition and the resin film thickness. Preferably, however, the heat treatment is carried out at a temperature of generally 70 to 150° C., preferably 80 to 120° C., for about 1 to 60 min.

Thereafter, a desired pattern is formed by development with an alkaline developing solution to dissolve and remove the unexposed areas. Development methods include shower development, spray development, immersion development, and paddle development. In general, the development is preferably carried out under conditions of temperature 20 to 40° C. and development time about 1 to 10 min. After development with an alkaline developing solution, washing with water is carried out followed by drying.

An example of the alkaline developing solution is an alkaline aqueous solution prepared, for example, by dissolving an alkaline compound such as sodium hydroxide, potassium hydroxide, aqueous ammonia, tetramethylammonium hydroxide, or choline in water to give a concentration of about 1 to 10% by weight. A proper amount of water-soluble organic solvents such as methanol or ethanol or surfactants may be added to the alkaline aqueous solution.

Further, in order to satisfactorily exert properties as an insulating film after the development, preferably, heat treatment is carried out to satisfactorily cure the photosensitive fluororesin composition. Curing conditions are not particularly limited. Preferably, however, depending upon the use of the cured film, heating is carried out in a temperature range of 50 to 200° C. for about 30 min to 10 hr to cure the photosensitive fluororesin composition.

The heating may be carried out in two stages from the viewpoint of satisfactorily accelerating curing of the photosensitive fluororesin composition or preventing the deformation of the pattern shape. For example, heating in the first stage is carried out in a temperature range of 50 to 120° C. for about 5 min to 2 hr and heating in the second stage is carried out in a temperature range of 80 to 200° C. for about 10 min to 10 hr for curing.

In the heat treatment, a hot plate, an oven, an infrared oven or the like may be used as heating equipment.

(Cured Film and Article Comprising the Cured Film)

The cured film according to the present invention may be produced using the photosensitive fluororesin composition, for example, by the above production process. The cured film is excellent in the prevention of adherence or wiping-off properties of a water repellent oil component, finger prints and the like, as well as in thermal shock resistance, adhesion or other properties. Therefore, the cured film is suitable as water repellent films and anti-fouling films.

Further, a cured film having a fine pattern with excellent resolution as shown in FIG. 1 can be produced by forming a cured film with a pattern using the photosensitive fluororesin composition.

Further, the article according to the present invention is an article having the cured film on its surface. In particular, when this cured film is an anti-fouling film, the film is effective as an anti-fouling article. Examples of such articles include displays such as CRTs, PDPs and LCDs, touch panels, semiconductor elements, and fingerprint reading sensors.

### EXAMPLES

The present invention will be described with reference to the following Examples. However, it should be noted that the present invention is not limited to these Examples. The term “parts” in the Examples and Comparative Examples means the term “parts by weight” unless otherwise specified.

At the outset, methods for evaluating properties of cured products in the Examples and Comparative Examples will be described.

<Evaluation Method>

Anti-Fouling Properties:

A photosensitive resin composition was spin coated onto a 6-inch silicon wafer. The coating was then heated on a hot plate at 110° C. for 3 min to form a 2 μm-thick even coating film. Thereafter, ultraviolet light from a high-pressure mercury lamp was irradiated to the coating film using an aligner through a pattern mask in an exposure at wavelength 350 nm of 5,000 J/m². Next, the exposed film was heated on a hot plate at 110° C. for 3 min (post-exposure heating: PEB) and was heated in a convection-type oven at 180° C. for 1 hr to form a cured film.

For the cured film, the contact angle with pure water was measured. Further, marking ink and fingerprint wiping-off properties were evaluated according to the following criteria.

(Wiping-Off Property Test)

A marking ink or fingerprint was adhered onto the surface of the cured film, and the surface of the cured film was rubbed with Kimwipe (manufactured by JuJo Kimberly). The wiping-off property was evaluated in terms of the number of times of rubbing necessary for wiping-off the marking ink or fingerprint.

AA: Only once needed.

A: Two to five times needed.

B: Five to ten times needed.

C: Ten or more times needed, or impossible to fully wipe off.

Scratch Resistance:

A photosensitive resin composition was spin coated onto a 6-inch silicon wafer, and a cured film was prepared in the same manner as in the anti-fouling property evaluation sample. On the surface of the cured film, #0000 steel wool was reciprocated ten times with applying load to the surface at a load of 500 g/cm². The surface of the cured film was then inspected for scratches.

AA: Neither separation nor scratches in the cured film was observed.

A: Streak-like scratches was slightly observed on the surface of the cured film.

B: Streak-like scratches was significantly observed on the surface of the cured film.

C: The cured film peeled.

Adhesion:

A photosensitive resin composition was spin coated onto a 6-inch silicon wafer, and a cured film was prepared in the same manner as in the anti-fouling property evaluation sample. The wafer coated with the cured film (hereinafter referred to as “test substrate”) was introduced into a PCT tester (manufactured by Tabai Espec Corp.) and was treated under conditions of 121° C./100% RH for 168 hr. Thereafter, the test substrate was subjected to a crosscut test according to a crosscut tape method (JIS K 5400; 10 squares×10 squares, size of each square: 1 mm×1 mm). The adhesion was evaluated in terms of the proportion of squares in which the cured film was unpeeled after the test based on all the squares.

Thermal Shock Resistance:

A photosensitive resin composition was spin coated onto a 6-inch silicon wafer, and a cured film was prepared in the same manner as in the anti-fouling property evaluation sample. For the wafer coated with the cured film, a resistance test (one cycle: −55° C./30 min to 150° C./30 min) was carried out in a thermal shock chamber (manufactured by Tabai Espec Corp.). The number of cycles necessary for causing defects such as cracks in the cured film was determined.

Resolution:

A pohotosensitive resin composition was spin coated onto a 6-inch silicon wafer. The coating was heated on a hot plate at 110° C. for 3 min to form a 2 μm-thick even coating film. Thereafter, ultraviolet light from a high-pressure mercury lamp was irradiated to the coating film using an aligner (MA-150, manufactured by SUSS MicroTec KK) through a pattern mask in an exposure at wavelength 350 nm of 3,000 to 6,000 J/m². Next, the exposed film was heated (PEB) on a hot plate at 110° C. for 3 min. The wafer coated with the coating film after PEB was then immersed in a 2.38 wt % aqueous tetramethylammonium hydroxide solution at 23° C. for 90 sec for development. The minimum dimension of the formed pattern was regarded as the resolution.

Next, each starting material used in Examples and Comparative Examples will be described.

<Fluorocopolymer (A)>

### Synthesis Example 1

The inside of a stainless steel autoclave (internal volume 1.5 liters) provided with an electromagnetic stirrer was fully replaced by nitrogen gas. Thereafter, 375 g of methyl isobutyl ketone, 39.2 g of ethyl vinyl ether (EVE), 47.9 g of 2-hydroxyethylvinylether (HEVE), 50.0 g of ADEKA REASOAP NE-30 (manufactured by Asahi Denka Co., Ltd.) as a nonionic reactive emulsifier, 5.0 g of 4-isopropylidene-1-methylcyclohexene-1 as a chain transfer agent, 2.5 g of VPS-0501 (manufactured by Wako Pure Chemical Industries, Ltd.) as an azo-containing polysiloxane, and 12.5 g of dilauroyl peroxide (LPO) as a polymerization initiator were charged into the autoclave. Next, 196.64 g of hexafluoropropylene (HFP) was charged, and a temperature rise was started. When the temperature within the autoclave reached 75° C., the pressure was 9.0×10⁵ Pa. While stirring in this state, the reaction was continued at 75° C. for 13 hr. Thereafter, when the pressure dropped to 6.1×10⁵ Pa, the autoclave was cooled with water to stop the reaction. In this state, the autoclave was allowed to stand until the temperature reached room temperature. The unreacted monomer was released, and the autoclave was opened to give a polymer solution. The nonvolatile concentration (effective component concentration) of the polymer solution was measured by drying the polymer solution on an aluminum dish at 150° C. for 5 min. As a result, the nonvolatile concentration was 33.1%.

The polymer solution thus obtained was poured into a methanol/water mixed solvent to precipitate the polymer, and then the polymer was washed with methanol/water mixed solvent and was dried in vacuo at 50° C. to give 157 g of a fluorocopolymer.

Next, 120 g of this fluorocopolymer, 180 g of methyl butyl ketone, 43.5 g of trimellite anhydride, and 1.0 g of triethylbenzylammonium chloride were charged into a glass reactor (internal volume 0.5 liter) provided with a stirrer, and a temperature rise was started. While stirring in this state, the reaction was continued at 110° C. for 2 hr to synthesize a carboxyl-containing fluorocopolymer (hereinafter referred to as a “fluorocopolymer (A-1)”) This fluorocopolymer (A-1) was dissolved in tetrahydrofuran (THF) to prepare a 0.5% solution. This solution was used for the determination of the number average molecular weight (Mn) by gel permeation chromatography. As a result, the number average molecular weight (Mn) in terms of polystyrene was 7,600.

### Synthesis Example 2

The inside of a stainless steel autoclave (internal volume 1.5 liters) provided with an electromagnetic stirrer was fully replaced by nitrogen gas. Thereafter, 810 g of ethyl acetate, 102.6 g of ethyl vinyl ether (EVE) and 81.6 g of crotonic acid (CA) were charged into the autoclave. Further, 2.5 g of VPS-0501 (manufactured by Wako Pure Chemical Industries, Ltd.) as an azo-containing polysiloxane, and 16.2 g of dilauroyl peroxide (LPO) as a polymerization initiator were charged. Next, 351.064 g of hexafluoropropylene (HFP) was charged, and a temperature rise was started. When the temperature within the autoclave reached 70° C., the pressure was 7.6×10⁵ Pa. While stirring in this state, the reaction was continued at 70° C. for 12 hr. Thereafter, when the pressure dropped to 6.3×10⁵ Pa, the autoclave was cooled with water to stop the reaction. In this state, the autoclave was allowed to stand until the temperature reached room temperature. The unreacted monomer was removed, and the autoclave was opened to give a polymer solution. The nonvolatile concentration (effective component concentration) of the polymer solution was measured by drying the polymer solution on an aluminum dish at 150° C. for 5 min. As a result, the nonvolatile concentration was 21.1%.

The polymer solution thus obtained was poured into water to precipitate the polymer, and then the polymer was washed with water and was dried in vacuo at 50° C. to give 240 g of a fluorocopolymer (hereinafter referred to as “fluorocopolymer (A-2)”). For the fluorocopolymer (A-2), the number average molecular weight (Mn) was determined in the same manner as in Synthesis Example 1 and was 1,800.

### Synthesis Example 3

The inside of a glass reactor (internal volume 0.5 liter) provided with a stirrer was fully replaced by nitrogen gas. Thereafter, 150 g of butyl acetate, 18 g of 2-(perfluorooctyl)ethyl acrylate (FA-108, manufactured by Osaka Organic Chemical Industry Ltd.), 28 g of ethyl acrylate (EA), 9 g of isobornyl acrylate (IBOA), and 45 g of 2-acryloyloxyethylhexahydrophthalic acid (HOA-HH: manufactured by Kyoeisha Chemical Co., Ltd.) were charged into the reactor. Further, 5.0 g of azobisisobutyronitrile (AIBN) was charged as a polymerization initiator, and a temperature rise was started. While stirring in this state, the reaction was continued at 75° C. for 6 hr. Further, the temperature was raised to 100° C., and the reaction was continued for 1 hr. The reactor was then cooled with water to stop the reaction. The nonvolatile concentration (effective component concentration) of the polymer solution was measured by drying the polymer solution on an aluminum dish at 175° C. for 10 min. As a result, the nonvolatile concentration was 40.8%.

Further, the solvent was removed by evaporation under the reduced pressure to give 97.5 g of a fluorocopolymer (hereinafter referred to as “fluorocopolymer (A-3)”). For this fluorocopolymer (A-3), the number average molecular weight (Mn) was determined in the same manner as in Synthesis Example 1 and was 8,000.

### Synthesis Example 4

A polymer solution was prepared in the same manner as in Synthesis Example 3, except that 18 g of 2-(perfluorooctyl)ethyl acrylate (FA-108: manufactured by Osaka Organic Chemical Industry Ltd.), 28 g of ethyl acrylate (EA), 9 g of isobornyl acrylate (IBOA), 45 g of 2-acryloyloxyethylhexahydrophthalic acid (HOA-HH: manufactured by Kyoeisha Chemical Co., Ltd.), and 1.0 g of VPS-0501 (manufactured by Wako Pure Chemical Industries, Ltd.) as an azo-containing polysiloxane were used instead of 18 g of 2-(perfluorooctyl)ethyl acrylate (FA-108: manufactured by Osaka Organic Chemical Industry Ltd.), 28 g of ethyl acrylate (EA), 9 g of isobornyl acrylate (IBOA), and 45 g of 2-acryloyloxyethylhexahydrophthalic acid (HOA-HH: manufactured by Kyoeisha Chemical Co., Ltd.). The nonvolatile concentration (effective component concentration) of the polymer solution was measured by drying the polymer solution on an aluminum dish at 175° C. for 10 min. As a result, the nonvolatile concentration was 41.0%.

Further, the solvent was removed by evaporation under the reduced pressure to prepare 98 g of a fluorocopolymer (hereinafter referred to as “fluorocopolymer (A-4)”). For this fluorocopolymer (A-4), the number average molecular weight (Mn) was determined in the same manner as in Synthesis Example 1 and was 9,000.

### Synthesis Example 5

99 g of a fluorocopolymer (hereinafter referred to as “fluorocopolymer (A-5)”) was prepared in the same manner as in Synthesis Example 4, except that 18 g of 2-(perfluorooctyl)ethyl acrylate (FA-108: manufactured by Osaka Organic Chemical Industry Ltd.), 18 g of ethyl acrylate (EA), 9 g of isobornyl acrylate (IBOA), 45 g of 2-acryloyloxyethylhexahydrophthalic acid (HOA-HH: manufactured by Kyoeisha Chemical Co., Ltd.), and 10 g of 2-isopropenylphenol (PIPE) were used instead of 18 g of 2-(perfluorooctyl)ethyl acrylate (FA-108: manufactured by Osaka Organic Chemical Industry Ltd.), 28 g of ethyl acrylate (EA), 9 g of isobornyl acrylate (IBOA), and 45 g of 2-acryloyloxyethylhexahydrophthalic acid (HOA-HH: manufactured by Kyoeisha Chemical Co., Ltd.). For this fluorocopolymer (A-5), the number average molecular weight (Mn) was determined in the same manner as in Synthesis Example 1 and was 8,000.

### Synthesis Example 6

99 g of a fluorocopolymer (hereinafter referred to as “fluorocopolymer (A-6)”) was prepared in the same manner as in Synthesis Example 4, except that 150 g of ethyl lactate was used instead of butyl acetate, and 18 g of 2-(perfluorooctyl)ethyl acrylate (FA-108: manufactured by Osaka Organic Chemical Industry Ltd.), 32 g of ethyl acrylate (EA), 30 g of 2-acryloyloxyethylhexahydrophthalic acid (HOA-HH: manufactured by Kyoeisha Chemical Co., Ltd.), and 20 g of 2-isopropenylphenol (PIPE) were used instead of 18 g of 2-(perfluorooctyl)ethyl acrylate (FA-108: manufactured by Osaka Organic Chemical Industry Ltd.), 28 g of ethyl acrylate (EA), 9 g of isobornyl acrylate (IBOA), and 45 g of 2-acryloyloxyethylhexahydrophthalic acid (HOA-HH: manufactured by Kyoeisha Chemical Co., Ltd.). For this fluorocopolymer (A-6), the number average molecular weight (Mn) was determined in the same manner as in Synthesis Example 1 and was 9,000.

### Synthesis Example 7

99 g of a copolymer (hereinafter referred to as “copolymer (A-7)”) was prepared in the same manner as in Synthesis Example 3, except that 46 g of ethyl acrylate (EA), 9 g of isobornyl acrylate (IBOA), and 45 g of 2-acryloyloxyethylhexahydrophthalic acid (HOA-HH: manufactured by Kyoeisha Chemical Co., Ltd.) were used instead of 18 g of 2-(perfluorooctyl)ethyl acrylate (FA-108: manufactured by Osaka Organic Chemical Industry Ltd.), 28 g of ethyl acrylate (EA), 9 g of isobornyl acrylate (IBOA), and 45 g of 2-acryloyloxyethylhexahydrophthalic acid (HOA-HH: manufactured by Kyoeisha Chemical Co., Ltd.). For this fluorocopolymer (A-7), the number average molecular weight (Mn) was determined in the same manner as in Synthesis Example 1 and was 10,500.

<Crosslinking Agent (B)>

B1: hexamethoxymethyl melamine (tradename: Cymel 300, manufactured by MITSUI CYTEC LTD.)

B2: tetramethoxymethyl glycoluril (tradename: Cymel 1174, manufactured by MITSUI CYTEC LTD.)<

Acid Generating Agent (C)>

C1: 4,7-di-n-butoxynaphthyl tetrahydrothio-phenonium trifluoromethanesulfonate

C2: styryl-bis(trichloromethyl)-s-triazine

<Solvent (D)>

D1: ethyl lactate

<Phenolic Resin (E)>

E1: poly(p-hydroxystyrene) (tradename: MARUKA LYNCUR S-2P, manufactured by Maruzen Petrochemical Co., Ltd.)

<Epoxy Resin (F)>

F1: bisphenol A epoxy resin (tradename: EP-828, manufactured by Japan Epoxy Resins Co., Ltd)

F2: bisphenol A epoxy resin (tradename: EP-152, manufactured by Japan Epoxy Resins Co., Ltd)

<Other Additives (G)>

G1: Titanium oxide particles

<Preparation and Evaluation of Photosensitive Fluororesin Composition>

### Examples 1 to 12

According to the proportions shown in Table 1, a fluorocopolymer (A), the crosslinking agent (B), the acid generating agent (C), and optionally the phenolic resin (E), the epoxy resin (F), and the other additives (G) were dissolved in the solvent (D) to prepare a photosensitive fluororesin composition. The amounts of the components (A) to (C) and (E) to (G) used were each solid equivalent.

The properties of this composition were measured by the above evaluation methods. The results are shown in Table 2.

### Comparative Example 1

According to the proportion shown in Table 1, the copolymer (A), the crosslinking agent (B), the acid generating agent (C), and the phenolic resin (E) were dissolved in the solvent (D) to prepare a photosensitive resin composition.

The properties of this composition were measured by the above evaluation methods. The results are shown in Table 2.

TABLE 1

| | | Crosslinking | Acid generating | | Phenolic | Epoxy | Other |
|---|---|---|---|---|---|---|---|
| | Copolymer | agent | agent | Solvent | resin | compound | additive |
| | (A) | (B) | (C) | (D) | (E) | (F) | (G) |
| | type/parts | type/parts | type/parts | type/parts | type/parts | type/parts | type/parts |
| Ex. 1 | A-1/100 | B1/100 | C1/8 | D1/380 | — | — | — |
| Ex. 2 | A-2/100 | B1/100 | C2/8 | D1/380 | — | — | — |
| Ex. 3 | A-3/100 | B1/150 | C1/10 | D1/480 | — | — | — |
| Ex. 4 | A-4/100 | B1/150 | C1/10 | D1/480 | — | — | — |
| Ex. 5 | A-4/100 | B2/150 | C1/10 | D1/480 | — | — | — |
| Ex. 6 | A-4/100 | B1/125 | C1/10 | D1/480 | E1/25 | — | — |
| Ex. 7 | A-5/100 | B1/125 | C1/10 | D1/480 | E1/25 | — | — |
| Ex. 8 | A-5/100 | B1/125 | C1/10 | D1/480 | E1/25 | F1/25 | — |
| Ex. 9 | A-5/100 | B1/125 | C1/10 | D1/480 | E1/25 | — | G1/30 |
| Ex. 10 | A-6/100 | B1/100 | C1/10 | D1/600 | E1/50 | F2/25 | — |
| Ex. 11 | A-6/100 | B1/100 | C1/12 | D1/750 | E1/100 | F2/30 | — |
| Ex. 12 | A-6/100 | B1/100 | C1/15 | D1/900 | E1/150 | F2/35 | — |
| Comp. Ex. 1 | A-7/100 | B1/125 | C1/10 | D1/480 | E1/25 | — | — |

Amounts of components (A) to (C) and (E) to (G) used are each solid equivalent.

TABLE 2

| | | | | | | Thermal | |
|---|---|---|---|---|---|---|---|
| | Anti-fouling properties | | | | | shock | |
| | | | Contact angle | Scratch | | resistance | Resolution |
| | Marking ink | Fingerprint | with pure water | resistance | Adhesion | (cycles) | (μm) |
| Ex. 1 | AA | AA | 107° | A | 100/100 | 900 | 5 |
| Ex. 2 | AA | A | 102° | A | 100/100 | 800 | 5 |
| Ex. 3 | A | A | 101° | A | 100/100 | 1000 | 5 |
| Ex. 4 | AA | AA | 107° | A | 100/100 | 1000 | 5 |
| Ex. 5 | AA | AA | 105° | A | 100/100 | 1000 | 2 |
| Ex. 6 | AA | AA | 102° | A | 100/100 | 1000 | 2 |
| Ex. 7 | AA | AA | 102° | A | 100/100 | 1000 | 2 |
| Ex. 8 | AA | A | 101° | AA | 100/100 | 1000 | 2 |
| Ex. 9 | AA | A | 100° | AA | 100/100 | 1000 | 5 |
| Ex. 10 | AA | A | 102° | A | 100/100 | 1000 | 3 |
| Ex. 11 | AA | A | 102° | A | 100/100 | 1000 | 3 |
| Ex. 12 | AA | A | 103° | AA | 100/100 | 1000 | 3 |
| Comp. Ex. 1 | C | C | 85° | B | 100/100 | 1000 | 5 |

### INDUSTRIAL APPLICABILITY

The formation of a protective film on the surface of electronic equipment and the like using the photosensitive fluororesin composition according to the present invention can protect the surface of the electronic equipment and the like against mechanical damage or the like. Further, the formation of a protective film can prevent the adherence of a water repellent oil component, fingerprints or the like onto the surface of electronic equipment or the like. Furthermore, even when the water repellent oil component, fingerprints and the like adhere, they can be easily wiped off. For example, in displays, a deterioration in visibility by the adherence of fingerprints or the like can be prevented, and, in semiconductor elements, malfunction caused by the adhered component can be prevented.

### BRIEF DESCRIPTION OF THE DRAWINGS

FIG. 1 is a photomicrograph of a pattern formed by pattering a cured film formed using a photosensitive fluororesin composition according to the present invention.

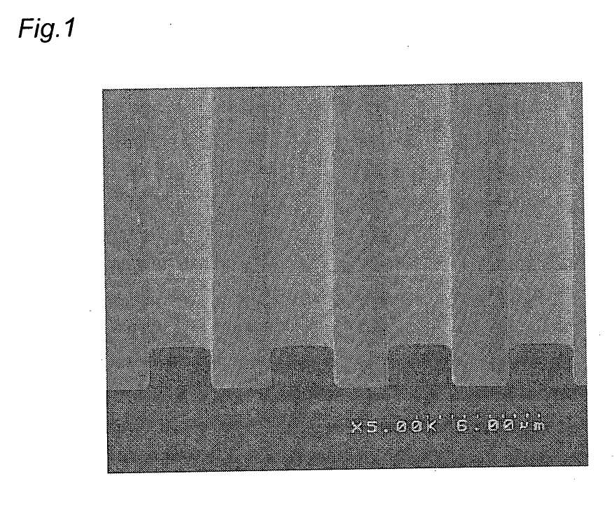

1. A photosensitive fluororesin composition comprising.
(A) a copolymer that comprises a fluorine atom,
(B) a compound that comprises at least two alkyletherized amino groups,
(C) a photosensitive acid generating agent, and
(D) a solvent.

2. The photosensitive fluororesin composition according to claim 1, wherein said copolymer (A) further comprises:
(A1) a structural unit derived from at least one monomer selected from fluoro(meth)acrylic esters, fluoroolefins, and fluoroolefin derivatives; and
(A2) a structural unit derived from at least one monomer selected from hydroxyl-containing monomers, epoxy-containing monomers, and carboxyl-containing monomers.

3. The photosensitive fluororesin composition according to claim 2, wherein said copolymer (A) further comprises:
(A3) a structural unit derived from at least one monomer selected from vinyl compounds, (meth)acrylic esters, unsaturated carboxylic acid esters, (meth)acrylamides, and unsaturated nitrites.

4. The photosensitive fluororesin composition according to claim 2, wherein said structural unit (A1) is a structural unit represented by formula (1): 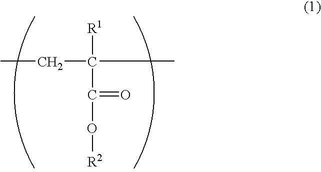
wherein R¹ represents a hydrogen atom or a methyl group; and R² represents a fluoroalkyl group having 2 to 20 carbon atoms.

5. The photosensitive fluororesin composition according to claim 2, wherein said structural unit (A1) is a structural unit represented by formula (2): 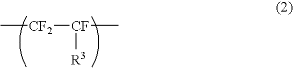
wherein R³ represents a fluorine atom, a perfluoroalkyl group having 1 to 10 carbon atoms, a perfluoroalkoxy group having 1 to 10 carbon atoms, or a chlorine atom.

6. The photosensitive fluororesin composition according to claim 2, wherein said structural unit (A2) is a structural unit derived from a phenolic hydroxyl-containing monomer.

7. The photosensitive fluororesin composition according to claim 1, wherein said copolymer (A) that comprises a fluorine atom further comprises a silicon atom.

8. The photosensitive fluororesin composition according to claim 7, wherein said copolymer (A) that comprises a fluorine atom further comprises a siloxane structural unit represented by formula (3): 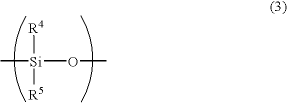
wherein R⁴ and R⁵ each independently represent a hydrogen atom, an alkyl group or a halogenated alkyl group having 1 to 10 carbon atoms, or an aryl group having 6 to 20 carbon atoms.

9. A cured film produced by curing a photosensitive fluororesin composition according to claim 1.

10. A cured film comprising a pattern formed by curing a photosensitive fluororesin composition according to claim 1.

11. A method for pattern formation comprising:
coating a photosensitive fluororesin composition according to claim 1 onto a support;
drying the coating to form a coating film;
exposing the coating film to light through a photomask; and
developing the exposed coating film with an alkaline developing solution.

12. The method for pattern formation according to claim 11, wherein the exposure is carried out using an exposure light source with an irradiating light wavelength of 300 nm to 500 nm.

13. A cured film having a pattern formed by a method for pattern formation according to claim 11.

14. An anti-fouling film comprising a cured film according to claim 9.

15. An anti-fouling film comprising a cured film according to claim 10.

16. An anti-fouling film comprising a cured film according to claim 13.

17. An article comprising a cured film according to claim 9 on a surface of the article.

18. An article comprising a cured film according to claim 10 on a surface of the article.

19. An anti-fouling article comprising an anti-fouling film according to claim 14 on a surface of the anti-fouling article.

20. An anti-fouling article comprising an anti-fouling film according to claim 15 on a surface of the anti-fouling article.
